(19) United States
(12) Patent Application Publication
(10) Pub. No.: US 2006/0164407 A1
(43) Pub. Date: Jul. 27, 2006

(54) Method and apparatus for defect correction in a display

(75) Inventor: Ronald S. Cok, Rochester, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 11/040,066

(22) Filed: Jan. 21, 2005

(51) Int. Cl. G09G 5/00

(52) U.S. Cl. 345/204

(57) ABSTRACT

A display device, comprising: a) a display having a plurality of pixels including one or more defective pixel(s) and one or more additional pixel(s); and b) a controller for driving the display pixels and for transforming an input signal into a compensated signal for selectively modifying the output of one or more additional pixel(s) in the display to compensate for the output of the defective pixel(s).

### FIELD OF THE INVENTION

The present invention relates to displays having a plurality of light-emitting elements and, more particularly, correcting for defective light-emitting elements in the display.

### BACKGROUND OF THE INVENTION

Flat-panel display devices, for example plasma, liquid crystal and Organic Light Emitting Diode (OLED) displays have been known for some years and are widely used in electronic devices to display information and images. Such devices employ both active-matrix and passive-matrix control schemes and can employ a plurality of light-emitting elements. The light-emitting elements are typically arranged in two-dimensional arrays with a row and a column address for each light-emitting element and having a data value associated with each light-emitting element to emit light at a brightness corresponding to the associated data value. However, such displays suffer from a variety of defects that limit the quality of the displays. In particular, displays may suffer from defective light-emitting elements that do not respond properly to control signals, for example, the defective light-emitting elements may be permanently turned on, permanently turned off, or brighter or dimmer than intended for a given control signal. These non-uniformities can be attributed to the light-emitting or light-controlling materials in the display or, for active-matrix displays, to variability in the thin-film transistors used to drive the light emitting elements. Moreover, applicants have determined through experiments that defective light-emitting elements vary in the accuracy of their response at different brightness levels so that a light-emitting element may have a more accurate response at some light levels than at others. In other words, a pixel may be defective at one light level but less defective or not defective at all at another light level. Furthermore, most displays are color displays having pixels with three colored light-emitting elements and defects may be found in one color light-emitting element of a display pixel but not in the other color light-emitting elements of the same pixel. Such defects reduce the quality, reduce the manufacturing yields, and increase the costs of flat-panel displays.

A variety of schemes have been proposed to correct for non-uniformities in displays. U.S. Pat. No. 6,081,073 entitled “Matrix Display with Matched Solid-State Pixels” by Salam granted Jun. 27, 2000 describes a display matrix with a process and control means for reducing brightness variations in the pixels. This patent describes the use of a linear scaling method for each pixel based on a ratio between the brightness of the weakest pixel in the display and the brightness of each pixel.

U.S. Pat. No. 6,414,661 B1 entitled “Method and apparatus for calibrating display devices and automatically compensating for loss in their efficiency over time” by Shen et al issued Jul. 2, 2002 describes a method and associated system that compensates for long-term variations in the light-emitting efficiency of individual organic light emitting diodes in an OLED display device by calculating and predicting the decay in light output efficiency of each pixel based on the accumulated drive current applied to the pixel and derives a correction coefficient that is applied to the next drive current for each pixel. The compensation system is best used after the display device has been calibrated to provide uniform light output. This patent provides a means for correcting the non-uniformities through the use of a look-up table.

U.S. Pat. No. 6,473,065 B1 entitled “Methods of improving display uniformity of organic light emitting displays by calibrating individual pixel” by Fan issued Oct. 29, 2002 describes methods of improving the display uniformity of an OLED. In order to improve the display uniformity of an OLED, the display characteristics of all organic-light-emitting-elements are measured, and calibration parameters for each organic-light-emitting-element are obtained from the measured display characteristics of the corresponding organic, light-emitting element. The calibration parameters of each organic light-emitting element are stored in a calibration memory. The technique uses a combination of look-up tables and calculation circuitry to implement uniformity correction.

Other techniques rely upon complex sensing and driving circuitry to provide uniformity correction. For example, US20020030647 entitled “Uniform Active Matrix OLED Displays” by Hack et al published Mar. 14, 20020 describes such a technique. In this design, an active-matrix display comprises an array of pixels, each pixel including an organic light-emitting device and at least one thin-film transistor. A uniformity correction circuit that is capable of producing a selected pixel brightness is connected to the array of pixels. The uniformity correction circuit is capable of maintaining the brightness of the pixels in a range that does not vary, for example, by more than about 5%-10% from their selected brightness values. In other examples, improved uniformity is achieved through complex pixel driving circuits in each pixel. For example, see EP0905673 entitled “Active matrix display system and a method for driving the same” by Kane et al published Mar. 31, 1999. These approaches can unfavorably reduce the area in the OLED display available for emitting light, reduce manufacturing yields, and are subject to uniformity variation in the pixel circuits themselves.

The techniques described above suffer from a variety of limitations, including reduced brightness, a need for periodic calibration, increased circuit complexity, or reduced gray-scale. Moreover, none of these techniques compensate for light-emitting elements that are stuck on, off, or at some intermediate value. Nor do they provide varying compensation at different brightness levels.

There is a need, therefore, for an improved method of compensating for defective light-emitting elements in a display.

### SUMMARY OF THE INVENTION

In accordance with one embodiment, the invention is directed towards a display device, comprising: a) a display having a plurality of pixels including one or more defective pixel(s) and one or more additional pixel(s); and b) a controller for driving the display pixels and for transforming an input signal into a compensated signal for selectively modifying the output of one or more additional pixel(s) in the display to compensate for the output of the defective pixel(s).

In a further embodiment, the invention is directed towards a method for the correction of the output of a flat-panel display in response to a display input signal comprising: a) providing a display having a plurality of pixels including one or more defective pixel(s) and additional pixel(s); and b) modifying the output of one or more of the additional pixel(s) in response to the display input signal to compensate for the output of the defective pixel(s).

### ADVANTAGES

In accordance with various embodiments, the present invention may provide the advantage of improved uniformity and quality in a display and improve manufacturing yields.

### BRIEF DESCRIPTION OF THE DRAWINGS

FIG. 1 is a schematic diagram according to one embodiment of the present invention;

FIG. 2 is a schematic diagram according to another embodiment of the present invention;

FIG. 3 is a flow diagram illustrating a method of an embodiment of the present invention;

FIG. 4 is a flow diagram illustrating a method of an embodiment of the present invention;

FIGS. 5a and 5b illustrate an input signal and a corresponding transformed signal according to one embodiment of the present invention; and

FIGS. 6a and 6b illustrate another input signal and a corresponding transformed signal according to one embodiment of the present invention.

### DETAILED DESCRIPTION OF THE INVENTION

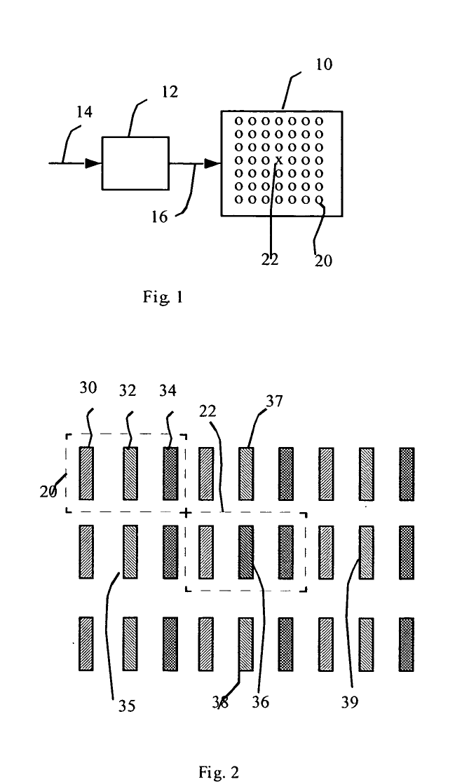

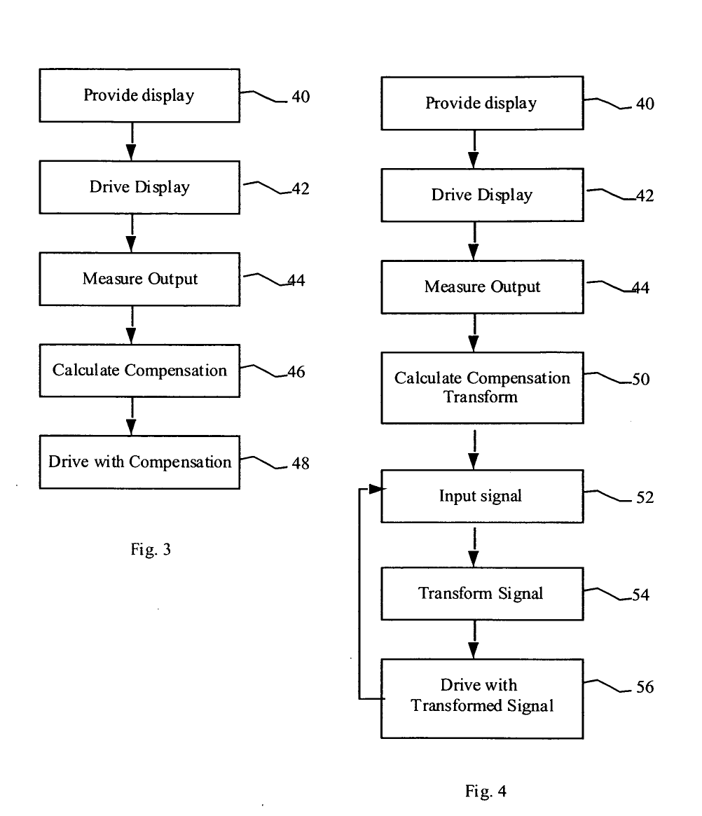

Referring to FIG. 1, one embodiment of the present invention comprises a display device having a display 10 with a plurality of pixels including one or more defective pixels 22 and one or more additional pixels 20; and a controller 12 for driving the display pixels and for transforming an input signal 14 into a compensated signal 16 for selectively modifying the output of one or more additional pixel(s) 20 in the display to compensate for the output of the defective pixel(s) 22. A defective pixel is one that does not respond as desired to a control signal. The additional pixel(s) 20 may, or may not, themselves be defective. In alternative embodiments of the present invention, the output of one additional pixel 20 may be modified or the output of several additional pixel(s) 20 may be modified, and the additional pixel(s) may be neighboring pixels to the defective pixel(s), for example surrounding the defective pixel(s) or on one side of the defective pixel(s). The display 10 of the present invention may be any flat-panel display, including an OLED display, an LCD display, or a plasma display.

The method for the correction of the output of a flat-panel display 10 in response to a display input signal 14 comprises the steps of first providing a display 10 having a plurality of pixels including one or more defective pixel(s) 22 and additional pixel(s) 20; and modifying the output of one or more of the additional pixel(s) 20 in response to the display input signal 14 to compensate for the output of the defective pixel(s) 22.

To determine the defective pixel(s) 22, the display 10 may be first driven by the controller 12 with a pre-determined signal. Each pixel 20 and 22 is examined and the light output measured. Means for measuring the light output from the pixels in a display are known and described in, for example co-pending, commonly assigned U.S. Ser. No. 10/858,260 (Kodak Docket 88142) and in US20040213449 entitled “Method and apparatus for optical inspection of a display”, the disclosures of which are incorporated by reference herein. Once the light output from each pixel in a display is measured, a compensation signal may be calculated for driving the defective pixel(s) 22 in combination with one or more additional pixel(s) 20 in the display 10 to compensate for the defective pixel(s) 22. The display 10 is then driven with the compensated signal.

More generally, a display device 10 according to the present invention will receive an input signal 14, transform the input signal 14 to compensate for the defective pixel(s) 22 in the display 10, and drive the display 10 with the transformed signal 16. The measured light output from each pixel is used to derive a transformation for an arbitrary input signal. As input signals 14 are supplied to the controller 12, they are transformed into signals 16 that compensate for the defective pixel(s) 22 in the display 10. Because the defective pixel(s) 22 may be stuck on or stuck off, the compensation involves driving the defective pixel(s) 22 in combination with the additional pixel(s) 20. The input, transform, output and drive process is then repeated. For example, a time-sequential stream of video images may be input, transformed, and then applied to the display to compensate for defective pixel(s) 22 in the display 10. In this way, the present invention controls the one or more defective pixel(s) 22 of the display 10 by driving each defective pixel 22 in combination with one or more additional pixel(s) 20 in the display 10 to compensate for the defective pixel(s) 22.

A wide variety of pixel defects are known in the art, and may include pixels whose response to a given signal is lower than desired (dim pixels), brighter than desired (bright pixels), stuck on (pixels permanently turned on at some brightness regardless of signal), or stuck off (dark pixels). The response of a defective pixel may vary according to the signal provided, so that the defects may be signal dependent. Some defective pixels will respond to a signal, the response of other defective pixels will be fixed regardless of signal. Moreover, the visibility of a defect may depend on viewing distance and display resolution, so that a compensation may be application, display design, resolution, or viewing distance dependent.

A wide variety of transformations may be employed to compensate for defective pixels. The choice of transformation will depend on the nature of the defects, the severity of the defects, the attributes of the display input signal (e.g., image brightness, contrast, and frequency), and the nature of the display application. In particular, the resolution and viewing distance may determine the type of compensation provided. For example, at a relatively high resolution or large viewing distance, the compensated signal drives the defective pixel and one or more additional pixel(s) to provide an output at an average of the desired response to the same signal. If a dim pixel is present, the compensation signal may drive one or more neighboring additional pixel(s) harder (brighter) in combination with the defective pixel so that the average response of the defective pixel(s) and additional pixel(s) is the same as the response would be if no defective pixels were present. Likewise, for example, if a bright pixel is present, the compensation signal may drive one or more neighboring additional pixels at a lower brightness (dimmer) in combination with the defective pixel so that the average response of the defective pixel(s) and additional pixel(s) is the same as the response would be if no defective pixels were present. Generally, it is preferred to compensate a defective pixel by modifying the brightness of an immediately neighboring pixel. However, the image content of the signal may dictate which neighboring pixel's output is, modified. Hence, the compensation may be image or application dependent. For example, if an input signal has a large, low-frequency component, a low-pass filtering technique may be preferred. If an input signal has a large, high-frequency component, it may be preferred to maintain the average local brightness.

If a relatively low resolution or small viewing distance is preferred, if a dim pixel is present, the compensation signal may drive one or more neighboring additional pixel(s) at a lower brightness (dimmer) to reduce the frequency response of the display to the dim pixel (essentially low-pass filtering the dim pixel and surrounding additional pixel(s)) so that the defective pixel(s) are less individually obtrusive. Likewise, for example, if a bright pixel is present, the compensation signal may drive one or more neighboring additional pixel(s) at a higher brightness.

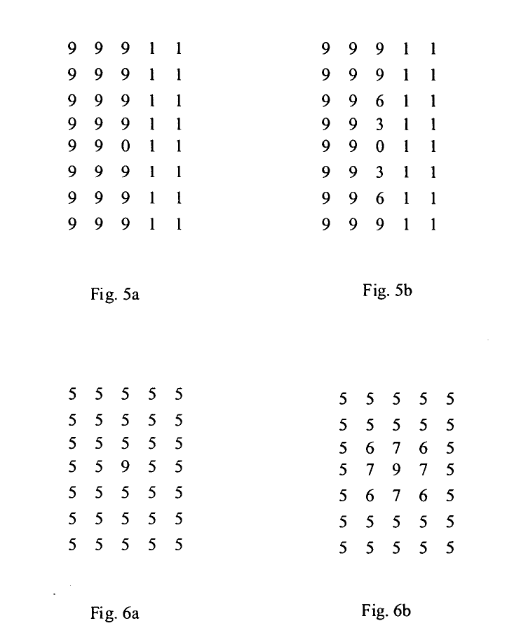

It is also possible, and may be preferred, to provide different compensations at different brightness levels. Applicants have determined that the visibility of a defect may depend, in part, on the average brightness of the display or local area in which the defective pixel is present. Hence, a different compensation scheme may be employed depending on the average brightness of the display or the local area surrounding a defective pixel. In general, at a high resolution or large viewing distance it is preferred that any compensation maintain the average brightness of the display at each brightness level, since the eye is very sensitive to changes in brightness over an area. However, for some signal types having edges for example, a large-scale change in brightness in one portion of the display is contrasted with another portion. If the defective pixel is on the edge, it may be more useful to modify the output of the neighboring additional pixel(s) to match that of the defective pixel, or to at least modify the output of the neighboring additional pixel(s) to be closer to the output of the defective pixels. The compensation may be edge-direction dependent. For example, FIG., 5a depicts an uncompensated signal having one defective pixel stuck at zero. FIG. 5b depicts a compensated signal having the two pixels above and below the defective pixel with modified values. Essentially, the vertical component of the signal is low-pass filtered while the horizontal component of the signal is unchanged. Likewise, in large areas of a common brightness, it can be useful to modify the output of neighboring good pixels to be closer to the output of a defective pixels to effectively hide the defective pixel, thereby creating a lower frequency defect, rather than the higher frequency defect resulting from a single pixel failure to which the human visual response system is more sensitive. The effect is to blur the defective pixel. For example, FIG., 6a depicts an uncompensated signal having one defective pixel stuck at 9. FIG. 6b depicts a compensated signal having the pixels surrounding the defective pixel with modified values. It is not necessary that every pixel with modified output be modified to the same extent. As illustrated in FIGS. 5b and 6b, pixels farther from the defective pixel are modified less.

In a color display, each pixel may include colored sub-pixels, for example red, green, or blue. A defective color pixel may have one defective sub-pixel, or several defective sub-pixels. The compensations described above may be applied to defective colored sub-pixels in combination with other additional sub-pixels of the same pixel or in combination with colored sub-pixels of another additional pixel, or both. If the compensation is applied to colored sub-pixels in combination with other additional sub-pixels of the same pixel, it is likely that a color shift may occur within the defective pixel. This may be compensated by shifting the color of neighboring pixels in an opposite direction. Referring to FIG. 2, a color display is illustrated having additional pixels 20 with red 30, green 32, and blue 34 sub-pixels. A defective pixel 22 has one defective green sub-pixel 36 and neighboring additional green sub-pixels 35, 37, 38 and 39. If, for example, defective green sub-pixel 36 is dim, the light output by the neighboring good green sub-pixels 35, 37,38 and 39 may be modified to compensate. This modification may depend on the scene content, the nature of the defect, and the application. Note that given the stripe pattern illustrated in FIG. 2 and commonly found in flat-panel displays, the colored sub-pixel elements above and below the defective colored sub-pixel are physically closer to the defective colored sub-pixel than the colored sub-pixel elements to the left and right. Hence, colored sub-pixel elements above and below the defective colored sub-pixel may be more effective in providing compensation than those to the left and right. Other pixel layouts may have other preferred compensating pixel elements. Since, in a color display, the resolution and viewing distance of the display is expected to be large enough that a viewer cannot optically distinguish the sub-pixel elements, it is likely that the compensation will not be obtrusive.

If a pixel or color sub-pixel is partially responsive to a signal, then means known in the art for uniformity correction may be employed to directly correct the output from the pixel or sub-pixel itself. However, for dim pixels, such corrections often drive a pixel much harder than the neighboring, good pixels. Thus, the lifetime of the display is reduced because the corrected, defective pixel will fail first. According to another embodiment of the present invention, such partially responsive defective pixels may be driven in combination with one or more additional pixels to compensate for the defect. By compensating both the additional and defective pixels, the defective pixels may not be driven as hard, thereby extending the lifetime of the display. If the pixel or sub-pixel is not responsive to a signal at all, then the only compensation available may be provided by driving one or more additional pixels to modify their light output.

Means for providing signal transformation in a controller are known in the art and can employ well-known hardware for image processing, in particular spatial filters applied to specific pixels.

The invention has been described in detail with particular reference to certain preferred embodiments thereof, but it will be understood that variations and modifications can be effected within the spirit and scope of the invention.

### PARTS LIST

10 display
12 controller
14 input signal
16 transformed signal
20 additional pixel
22 defective pixel
30 red sub-pixel
32 green sub-pixel
34 blue sub-pixel
35 neighboring green sub-pixel
36 defective green sub-pixel
37 neighboring green sub-pixel
38 neighboring green sub-pixel
39 neighboring green sub-pixel
40 provide display step
42 drive display step
44 measure output step
46 calculate compensation step
48 drive with compensation step
50 calculate compensation transform step
52 input signal step
54 transform signal step
56 drive with transformed signal step

1. A display device, comprising:
a) a display having a plurality of pixels including one or more defective pixel(s) and one or more additional pixel(s); and
b) a controller for driving the display pixels and for transforming an input signal into a compensated signal for selectively modifying the output of one or more additional pixel(s) in the display to compensate for the output of the defective pixel(s).

2. The display device of claim 1 wherein the display is an OLED display, an LCD display, or a plasma display.

3. The display device of claim 1 wherein the one or more defective pixel(s) includes at least one pixel that is brighter than the average brightness of the other pixels in the display when driven with a similar given signal.

4. The display device of claim 3 wherein the compensated signal drives one or more additional pixel(s) to be dimmer for a given signal to compensate for the defective pixel.

5. The display device of claim 3 wherein the compensated signal drives one or more additional pixel(s) to be brighter for a given signal to compensate for the defective pixel.

6. The display device of claim 1 wherein the one or more defective pixel(s) include at least one pixel that is dimmer than the average brightness of the other pixels in the display when driven with a similar signal.

7. The display device of claim 6 wherein the compensated signal drives one or more additional pixel(s) to be brighter for a given signal to compensate for the defective pixel.

8. The display device of claim 6 wherein the compensated signal drives one or more additional pixel(s) to be dimmer for a given signal to compensate for the defective pixel.

9. The display device of claim 1 wherein the defective pixel comprises different colored sub-pixels, the defect is present in at least one of the colored sub-pixels, and wherein the compensated signal selectively modifies the output of a similar colored sub-pixel of one or more additional pixel(s) in the display, selectively modifies the output of different colored sub-pixels of the defective pixel, or both, to compensate for the output of the defective pixel(s).

10. The display device of claim 1 wherein the additional pixel(s) that have their output modified by the compensated signal are neighboring pixel(s) to the defective pixel(s).

11. The display device of claim 1 wherein the defective pixel(s) are not responsive to a signal from the controller such that the pixel output is stuck on, off, or at an intermediate value.

12. The display device of claim 1 wherein the defective pixel(s) are partially responsive to a signal from the controller.

13. The display device of claim 12 wherein the controller drives both the defective pixel(s) and the additional pixel(s) with a compensated signal whereby the defect is compensated.

14. The display device of claim 12 wherein the controller drives only the additional pixel(s) with a compensated signal whereby the defect is compensated.

15. The display device of claim 1 wherein the compensated signal drives one or more additional pixel(s) so that the change in light output from the additional pixel(s) due to the compensation equals the difference in light output from the defective pixel and the average light output from the other pixels in the display when driven with a similar signal.

16. The display device of claim 1 wherein the compensated signal selectively modifies the output of more than one additional pixel in the display to compensate for the output of a defective pixel.

17. The display device of claim 16 wherein the more than one additional pixels include pixels that are not driven equally.

18. The display device of claim 16 wherein the compensated signal does not compensate each additional pixel equally.

19. The display device of claim 1 wherein a plurality of different compensation signals are provided for one or more defective pixel(s) for a corresponding plurality of input signal brightness levels.

20. A method for the correction of the output of a flat-panel display in response to a display input signal comprising:
a) providing a display having a plurality of pixels including one or more defective pixel(s) and additional pixel(s); and
b) modifying the output of one or more of the additional pixel(s) in response to the display input signal to compensate for the output of the defective pixel(s).

21. A method of claim 20, further comprising identifying the one or more defective pixel(s) by driving the display with a pre-determined signal and measuring the light output from each pixel of the display.

22. A method of claim 20 wherein the output of the display is modified by transforming an input signal into a compensated signal for selectively modifying the output of one or more neighboring pixel(s) in the display when driving the one or more defective pixel(s), and driving the display with the compensated signal.

23. The method of claim 22 wherein a plurality of different compensation signals are provided for the defective pixel(s) for a corresponding plurality of brightness levels.

24. The method of claim 20 wherein the compensation is dependent on the attributes of the display input signal.

25. The method of claim 20 wherein the output of one or more of the defective pixel(s) is modified in combination with the additional pixel(s).
